(19) United States
(12) Patent Application Publication
(10) Pub. No.: US 2026/0278564 A1
(43) Pub. Date: Sep. 17, 2026

(54) SPORTS ECOSYSTEM PLATFORM

(71) Applicant: Winsty AB, Stockholm (SE)

(72) Inventors: Adam ENGQVIST, Uppsala (SE); Håkan ENGQVIST, Uppsala (SE)

(21) Appl. No.: 19/565,720

(22) Filed: Mar. 13, 2026

Related U.S. Application Data
(60) Provisional application No. 63/771,754, filed on Mar. 14, 2025.

(51) Int. Cl. G06Q 10/42

(52) U.S. Cl. CPC G06Q 10/42

(57) ABSTRACT

A digital platform is provided to connect players, teams, sponsors, agents, and/or supporters within a sports ecosystem. Players can create detailed profiles showcasing their skills, statistics, and multimedia content, while teams and other stakeholders can register and interact based on tailored criteria using, for instance, an AI-powered matching algorithm. The platform preferably offers advanced privacy controls, facilitates efficient communication, and monetizes through targeted advertising, premium features, and connection fees.

### CROSS-REFERENCE TO RELATED APPLICATION

This application claims priority to U.S. provisional application number 63/771,754 filed Mar. 14, 2025, which is incorporated by reference herein in its entirety.

### TECHNICAL FIELD

The present invention generally relates to sports ecosystem, and in particular to a digital platform designed to connect, for instance, players, teams, sponsors, agents, and/or supporters within the sports ecosystem.

### BACKGROUND

In the dynamic world of sports, finding the right connections between players and teams is a persistent challenge. When players are released from a team or are actively seeking new opportunities, the process of identifying and connecting with potential teams or managers is often inefficient and fragmented. Similarly, teams in need of skilled players frequently struggle to identify suitable candidates who can enhance their performance. This gap in connectivity creates significant delays and missed opportunities on both ends.

Beyond players and teams, other stakeholders, such as supporters, sponsors, and agents also face hurdles in establishing meaningful connections. Supporters seek closer interaction with their favorite teams and players, sponsors aim to identify the right partnerships to enhance brand visibility, and agents require efficient ways to connect players with career-defining opportunities.

A comprehensive solution that bridges these gaps is highly needed. Such a solution would streamline communication, simplify the matchmaking process, and foster a more connected sports ecosystem, benefiting all parties involved. By addressing this critical need, the sports industry can unlock its full potential, enabling smoother transitions, stronger teams, and more engaged communities.

### SUMMARY

The embodiments provide a digital platform designed to connect players, teams, sponsors, agents, and/or supporters within a sports ecosystem. Players can create detailed profiles showcasing their skills, statistics, and multimedia content, while teams and other stakeholders can register and interact based on tailored criteria using, for instance, an artificial intelligence (AI) powered matching algorithm. The digital platform preferably offers advanced privacy controls, facilitates efficient communication, and monetizes through targeted advertising, premium features, and connection fees. By structuring player and club data into machine-readable multidimensional representations and automatically computing compatibility scores using adaptive weighting, the platform improves large-scale matching efficiency and reduces computational search complexity in distributed sports recruitment environments.

An aspect of the embodiments relates to a computer-implemented method for operating a digital platform that connects participants in a sports ecosystem. The method comprises storing, in a database, profile records for a plurality of users including at least player profiles and club profiles, wherein each player profile includes player-related data comprising a sports identifier, position data, performance statistics, availability status, and achievement data. The method also comprises generating, by one or more processors and for a player profile, a player vector derived from a set of features extracted from the player-related data included in the player profile. The method further comprises generating, by the one or more processors and for a club profile, a club requirement vector derived from a recruitment post of the club profile. The recruitment post specifies sport, position requirement, league division and location. The method additionally comprises computing a compatibility score between the player vector and the club requirement vector using a weighted similarity function that applies a plurality of feature weights. The method comprises producing, based on the compatibility score, a ranked recommendation output comprising at least one of (i) a recruitment candidate player set associated with recruitment post of the club profile or (ii) a set of recommended recruitment posts for the player profile. The method also comprises receiving, via a client device interface, an application interest signal from the player for a recruitment post of the set of recommended recruitment posts, and presenting, to a club user associated with the club profile, an evaluation interface that sequentially renders candidate player profiles associated with application interest signals for the recruitment post and that accepts an accept input or a reject input for each rendered candidate player profile. The method further comprises, in response to receiving the accept input by the club user for a candidate player profile for which the player previously generated the application interest signal, creating a mutual connection record that authorizes the club user to access player-related data of the player profile and enabling direct messaging between the club user and the player via the digital platform. The method additionally comprises, in response to receiving the reject input by the club user, removing the candidate player profile from the recruitment candidate set associated with the recruitment post without creating the mutual connection record.

Another aspect of the embodiments relates to a system for operating a digital platform connecting participants in a sports ecosystem. The system comprises one or more processors and one or more memories storing instructions that, when executed by the one or more processors, cause the one or more processors to store, in a database, profile records for a plurality of users including at least player profiles and club profiles, wherein each player profile includes player-related data comprising a sports identifier, position data, performance statistics, availability status, and achievement data. The instructions also cause the one or more processors to generate, for a player profile, a player vector derived from a set of features extracted from the player-related data included in the player profile, and generate, for a club profile, a club requirement vector derived from a recruitment post of the club profile, wherein the recruitment post specifies sport, position requirement, league division and location. The instructions further cause the one or more processors to compute a compatibility score between the player vector and the club requirement vector using a weighted similarity function that applies a plurality of feature weights. The instructions additionally cause the one or more processors to produce, based on the compatibility score, a ranked recommendation output comprising at least one of (i) a recruitment candidate player set associated with recruitment post of the club profile or (ii) a set of recommended recruitment posts for the player profile. The instructions further cause the one or more processors to receive an application interest signal from the player for a recruitment post of the set of recommended recruitment posts, and present, to a club user associated with the club profile, an evaluation interface that sequentially renders candidate player profiles associated with application interest signals for the recruitment post and that accepts an accept input or a reject input for each rendered candidate player profile. The instructions further cause the one or more processor to, in response to receiving the accept input by the club user for a candidate player profile for which the player previously generated the application interest signal, create a mutual connection record that authorizes the club user to access player-related data of the player profile and enabling direct messaging between the club user and the player via the digital platform, and, in response to receiving the reject input by the club user, remove the candidate player profile from the recruitment candidate set associated with the recruitment post without creating the mutual connection record.

A further aspect of the embodiments relates to a non-transitory computer-readable medium storing instructions that, when executed by one or more processors, cause the one or more processors to perform operations comprising storing, in a database, profile records for a plurality of users including at least player profiles and club profiles, wherein each player profile includes player-related data comprising a sports identifier, position data, performance statistics, availability status, and achievement data. The operations also comprise generating, by one or more processors and for a player profile, a player vector derived from a set of features extracted from the player-related data included in the player profile, and generating, by the one or more processors and for a club profile, a club requirement vector derived from a recruitment post of the club profile, wherein the recruitment post specifies sport, position requirement, league division and location. The operations further comprise computing a compatibility score between the player vector and the club requirement vector using a weighted similarity function that applies a plurality of feature weights, and producing, based on the compatibility score, a ranked recommendation output comprising at least one of (i) a recruitment candidate player set associated with recruitment post of the club profile or (ii) a set of recommended recruitment posts for the player profile. The operations additionally comprise receiving, via a client device interface, an application interest signal from the player for a recruitment post of the set of recommended recruitment posts. The operations further comprise presenting, to a club user associated with the club profile, an evaluation interface that sequentially renders candidate player profiles associated with application interest signals for the recruitment post and that accepts an accept input or a reject input for each rendered candidate player profile. The operations additionally comprise, in response to receiving the accept input by the club user for a candidate player profile for which the player previously generated the application interest signal, creating a mutual connection record that authorizes the club user to access player-related data of the player profile and enabling direct messaging between the club user and the player via the digital platform, and, in response to receiving the reject input by the club user, removing the candidate player profile from the recruitment candidate set associated with the recruitment post without creating the mutual connection record.

### BRIEF DESCRIPTION OF THE DRAWINGS

The embodiments, together with further objects and advantages thereof, may best be understood by making reference to the following description taken together with the accompanying drawings, in which:

FIGS. 1A and 1B illustrate examples of the digital platform’s home screen, providing users with an introduction to the digital platform.

FIGS. 2A and 2B illustrate examples of the digital platform’s user selection process, where users choose their role within the digital platform.

FIGS. 3A and 3B illustrate examples of the digital platform’s profile creation process for players. Users can enter key details, such as position, age, current club, personal bio and stats.

FIGS. 4A and 4B illustrate examples of a player profile within the digital platform. The profile presents details, such as the player’s name, current team, league division, follower count, player information, including position.

FIGS. 5A and 5B illustrate examples of a player profile within the digital platform, displaying key personal details such as age, current club, and a short biography.

FIGS. 6A and 6B illustrate examples of the achievements and stats section of a player profile within the digital platform.

FIGS. 7A and 7B illustrate examples of the highlights section within a player profile on the digital platform.

FIGS. 8A and 8B illustrate examples of the news feed within the digital platform. This section provides users with updates related to players recruitment, team announcements, and other relevant sports news.

FIGS. 9A, 9B and 9C illustrate examples of the search feature within the digital platform. Users can search for available positions in sports organizations by filtering based on sports, region, position and/or league division.

FIGS. 10A and 10B illustrate examples of a player recruitment post within the digital platform´s search function. Additionally, a “like” or “apply now” button is visible, allowing players to apply for the opportunity.

FIGS. 11A and 11B illustrate examples of the application confirmation process within the digital platform. After a player clicks the “like” or “apply now” button on a player recruitment post, (10A) a confirmation dialog appears, asking if they want to proceed with their application, or (10B) the interface presents an application status indicator confirming that the application has already been submitted and disabling further duplicate submissions.

FIG. 12 illustrates an example of the application submission process within the digital platform. After a player confirms their application for a player recruitment post, a notification appears, confirming that the application has been successfully sent to the club.

FIGS. 13A and 13B illustrate examples of the messaging feature within the digital platform, activated when a match occurs between a player and a club.

FIGS. 14A and 14B illustrate examples of the direct messaging feature within the digital platform, following a successful match between a player and a club.

FIGS. 15A and 15B illustrate examples of a club profile within the digital platform. The profile provides key details about the club, including its name, league, location, founding year, home arena, and general information.

FIGS. 16A and 16B illustrate examples of a club profile’s active player recruitment posts within the digital platform. Each listing includes engagement metrics, such as the number of applications received.

FIGS. 17A and 17B illustrate examples of the swipe-based interface within the digital platform, where clubs can review players who have applied in their recruitment post.

FIGS. 18A and 18B illustrate examples of how a player’s profile appears within the swipe interface on the digital platform. The club can view their stats before making a recruitment decision.

FIGS. 19A and 19B illustrate examples of the player profile review interface within the digital platform. Clubs can view a player’s profile, including their video highlights, before making a decision. (FIG. 19A) At the bottom of the figure, it illustrates that clubs have the option to “dislike” or “like” the player.

FIG. 20A and 20B illustrate examples of the sports selection interface during the registration process within the digital platform. After entering the app, users are prompted to select the sports they are interested in.

FIG. 21 illustrates an example system for providing a digital platform designed to connect players, teams, sponsors, agents, and/or supporters within a sports ecosystem.

FIG. 22 illustrates an example of a level 0 digital flow diagram (DFD) of the digital platform.

FIG. 23 illustrates an example of a level 1 DFD of the digital platform.

FIG. 24 illustrates an example of a level 2 DFD of the digital platform.

### DETAILED DESCRIPTION

The embodiments relate to a digital platform designed to connect, for instance, players, teams, sponsors, agents, and/or supporters within a sports ecosystem. The digital platform could be accessed using, for instance, a web browser by visiting a web site providing the digital platform services or using a dedicated application (app) on a smartphone or tablet. The embodiments thereby provide a digital platform interconnecting people in a similar way to LinkedIn®. However, whereas LinkedIn® is a networking platform designed to help individuals and businesses contact, share information and find job opportunities, the embodiments provide a streamlined solution to connect stakeholders within the sports ecosystem, enhancing opportunities and fostering meaningful relationships.

The digital platform comprises one or more key or core features including, but not limited to, player profiles, team or club profiles, sponsor, agent, and supporter profiles, matching algorithm, privacy and visibility control, recruitment system and/or monetization model.

### Player Profiles

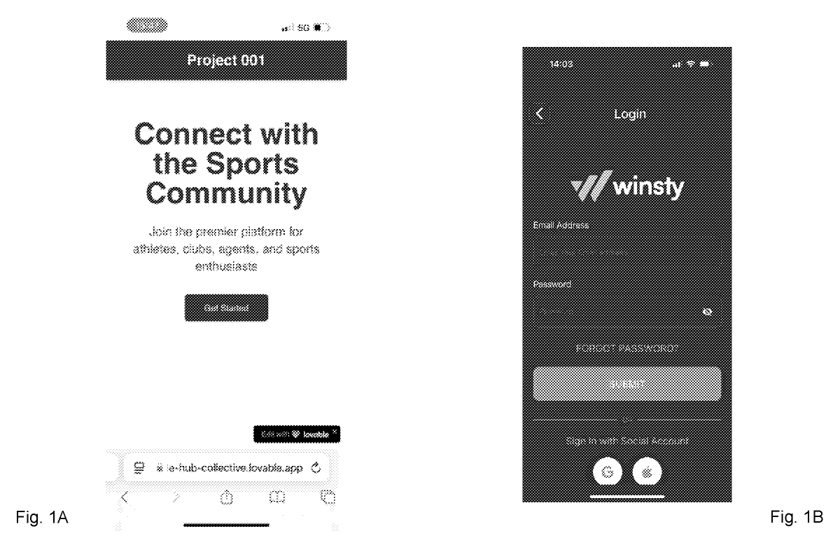

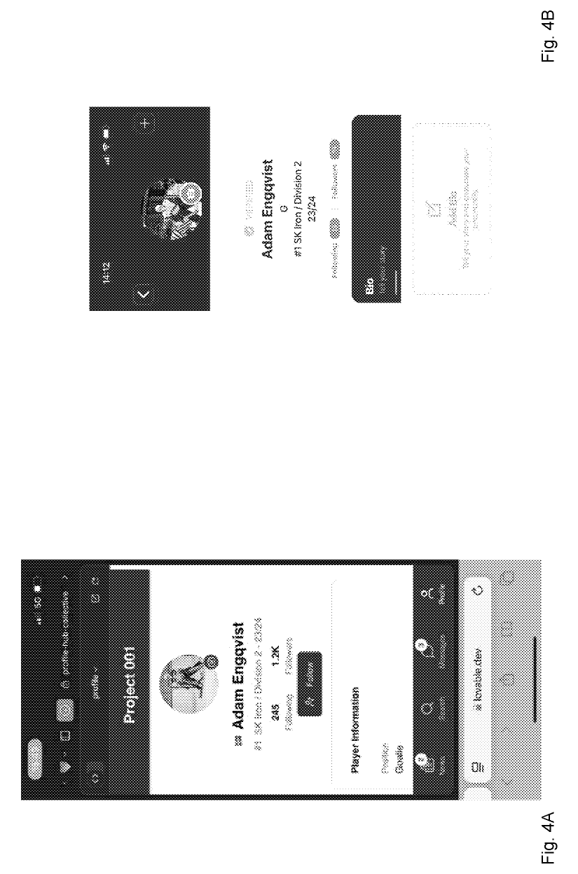

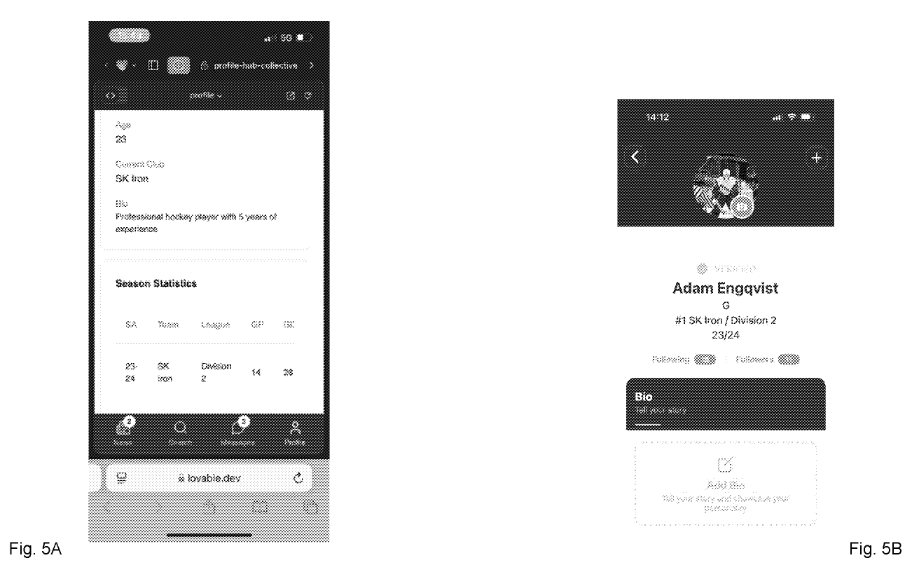

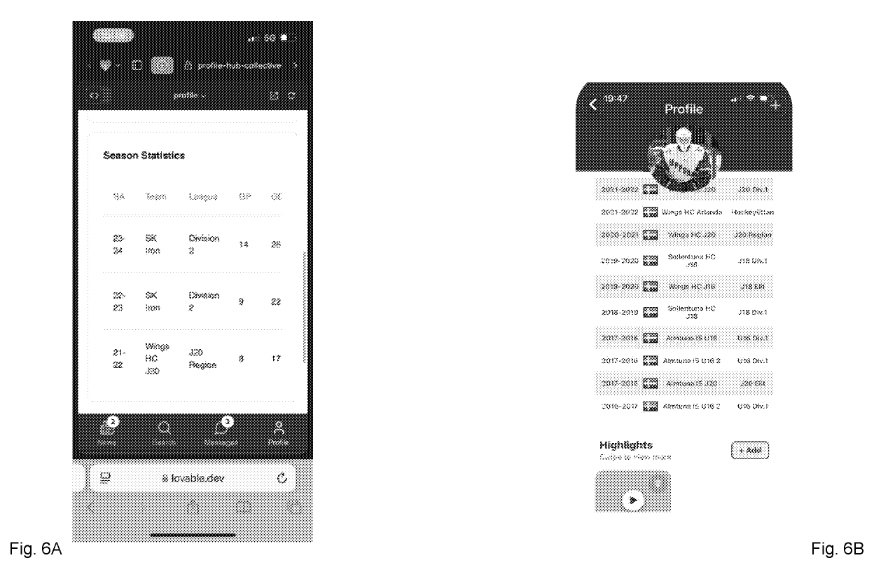

Players create detailed profiles showcasing their skills, stats, playing position, achievements, and/or highlight videos, see FIGS. 1-7, 20A, 20B.

Players can update their availability status, e.g., "Actively Looking for a Team", and choose to remain visible or non-visible depending on their preferences.

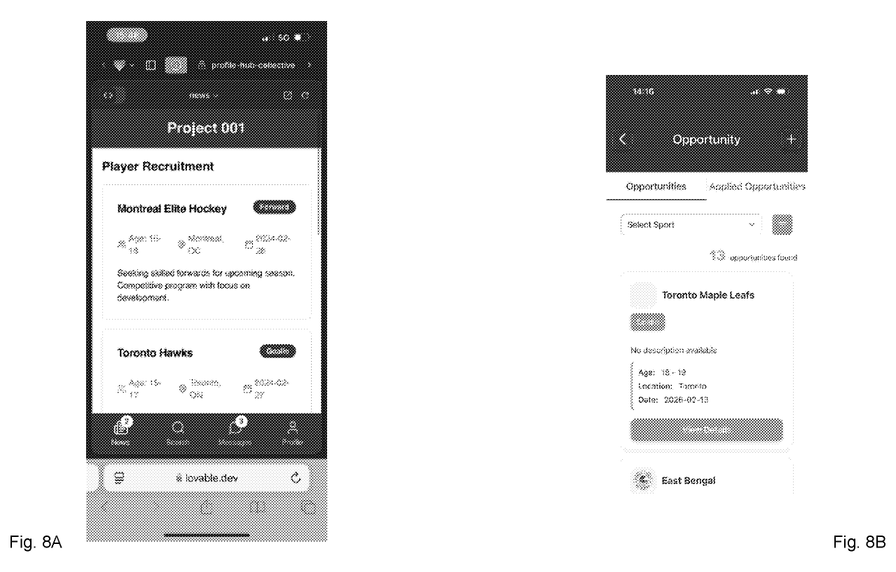

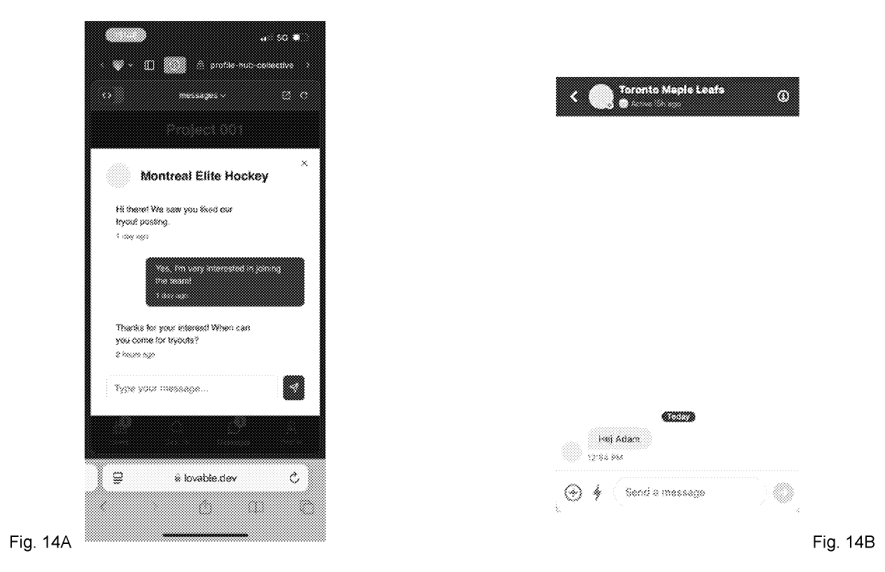

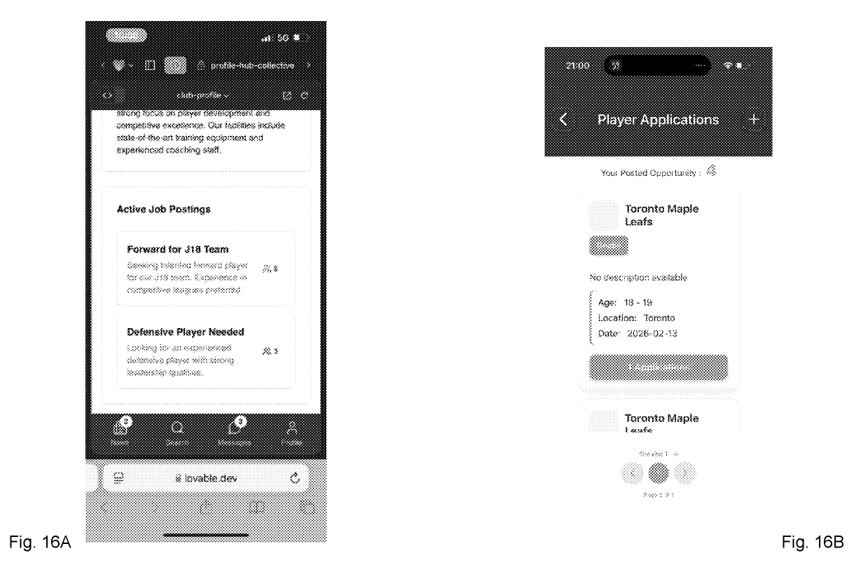

Players can use the digital platform to discover and respond to advertisements from clubs seeking players, see FIGS. 8-15.

The AI-powered tools of the digital platform help players optimize their profiles for maximum visibility to recruiters.

### Team/Club Profiles

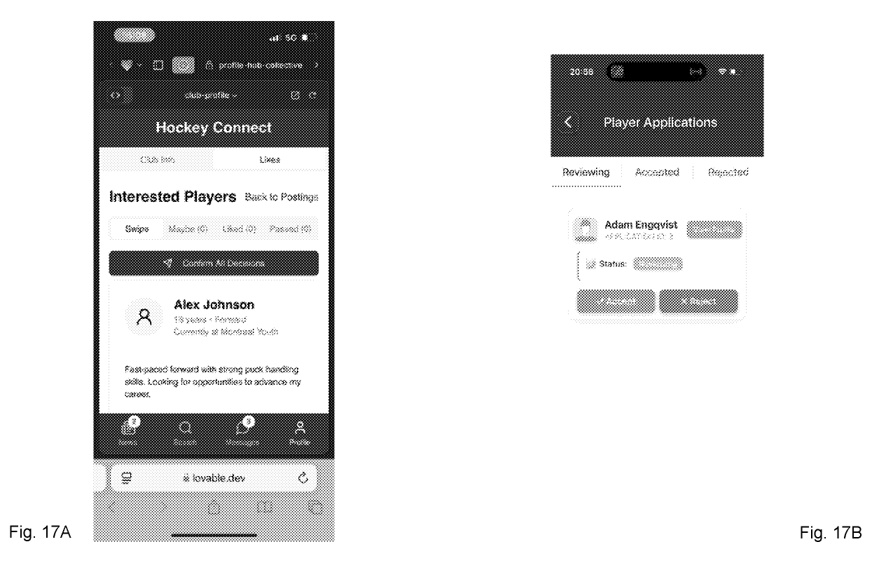

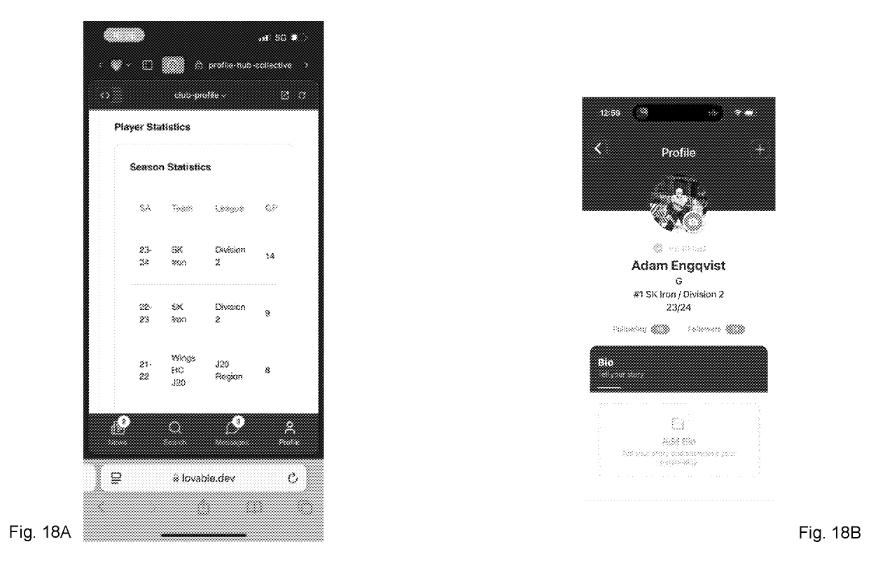

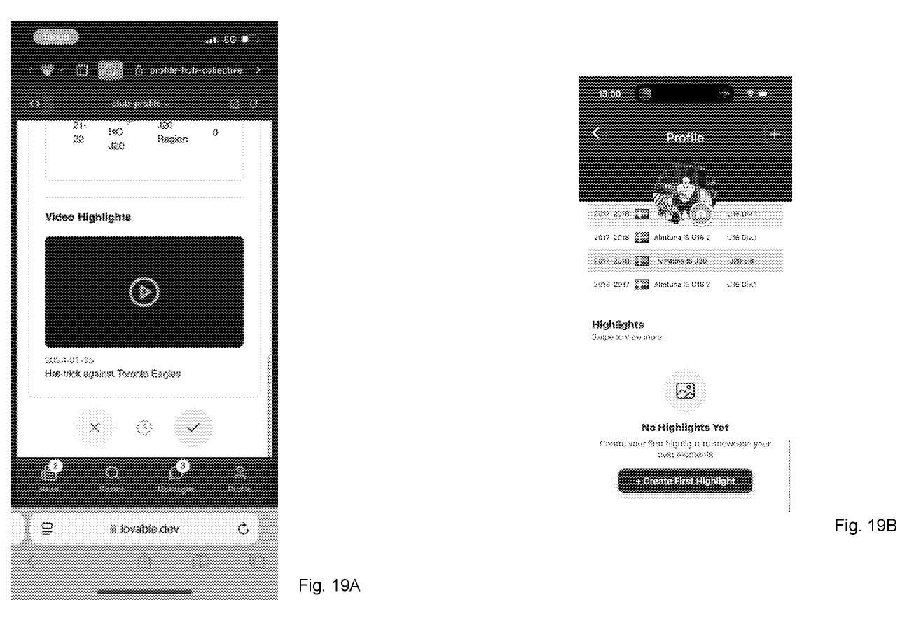

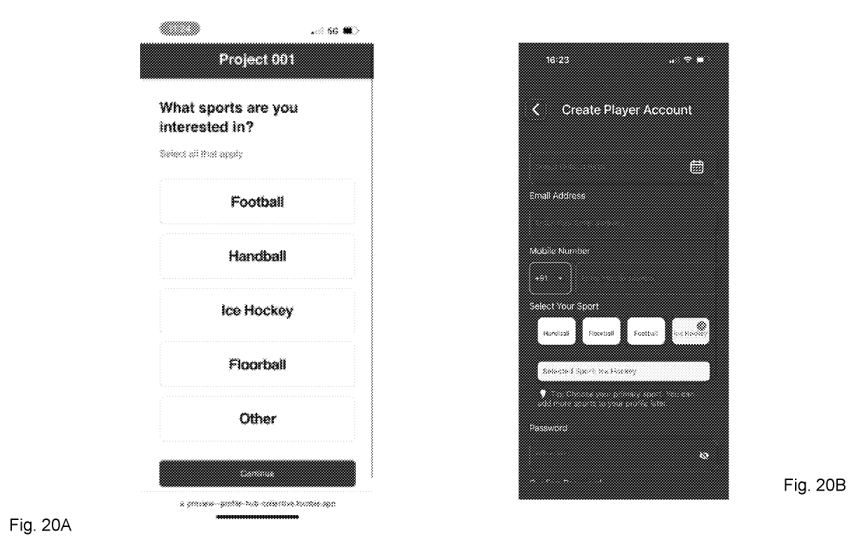

Teams and clubs can register to highlight their history, achievements, and opportunities, e.g., open positions for players, see FIGS. 1-2, 15-19.

Teams and clubs can post advertisements indicating the need for players, which players can then discover and respond to, see FIG. 16.

Teams and clubs can actively search for players based on specific criteria, such as position, experience, or stats.

A messaging and calendar system helps schedule tryouts or interviews.

### Profiles for Sponsors, Agents, and Supporters

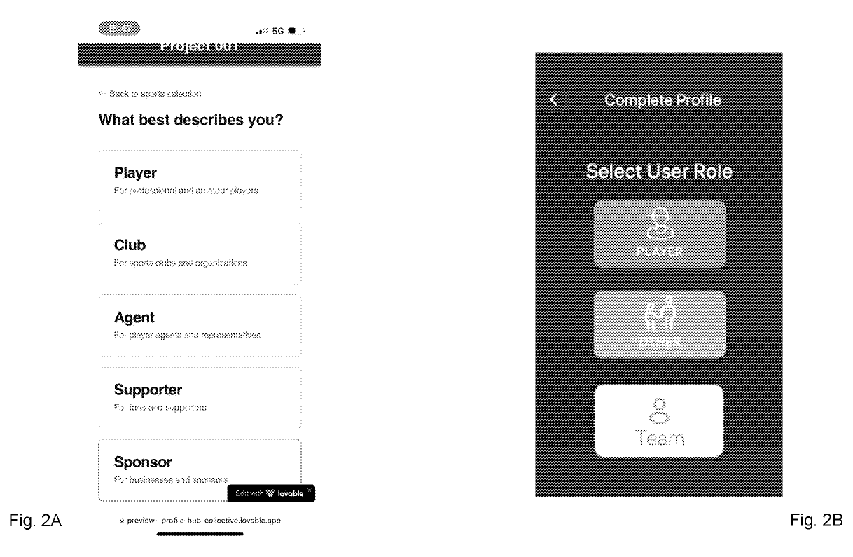

Sponsors can showcase sponsorship opportunities and discover players or teams that align with their brand values, see FIGS. 1-2.

Agents can manage multiple player profiles, connect with teams, and identify sponsorship opportunities, see FIGS. 1-2.

Supporters can use the digital platform to follow players, teams, or leagues and engage with content like videos, match schedules, and merchandise, see FIGS. 1-2, 7, 19.

### Matching algorithm

An AI-powered algorithm matches players with teams based on mutual interests, skills, and requirements. The matching algorithm may further perform automated feature extraction from player-generated data, including performance statistics, temporal availability data, and engagement signals. The extracted features are normalized and stored in a structured feature space to enable computational comparison with dynamically generated club requirement profiles.

Sponsors and agents can also receive tailored suggestions for relevant players, teams or clubs.

The matching algorithm may further process player-uploaded video content using computer vision techniques to extract performance indicators including skating speed, shot velocity, positional movement patterns, and puck interaction metrics. The extracted video-derived features are incorporated into the player vector to improve matching accuracy.

The platform may further generate individualized training recommendations based on detected performance deficiencies identified through the video analysis, including shot improvement suggestions and movement optimization guidance.

The matching engine may further generate ranked club opportunity recommendations for players by automatically prioritizing club opportunities based on computed compatibility scores, historical placement success rates, and predicted player development trajectories, thereby reducing manual search complexity for the player.

### Privacy and Visibility Control

Users can control who sees their profiles or activity, ensuring privacy while maintaining engagement with relevant opportunities.

### Recruitment System for Teams or Clubs

Teams or clubs can use the digital platform to streamline recruitment and simplify the selection process. For instance, the application preferably introduces a swipe-based system to clubs.

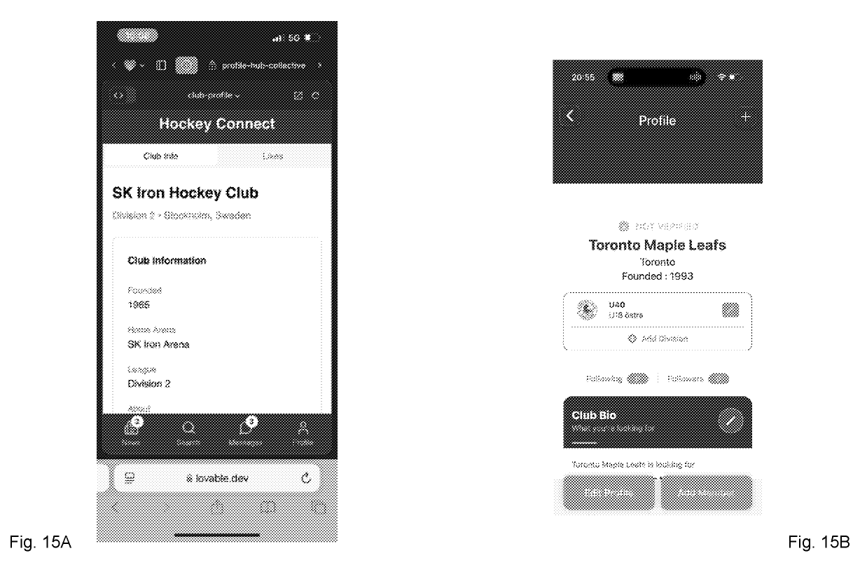

Players can browse club recruitment advertisements in the search function and express interest by “liking” an advertisement, see FIGS. 14, 16.

The swipe-based evaluation interface is preferably operatively coupled to the matching engine such that each swipe interaction generates feedback signals stored in the database and used to update the compatibility scoring model. This enables dynamic refinement of subsequent player recommendations based on detected recruiter preference patterns.

Teams and clubs can use a swipe-based system to review potential player applications.

When a team or club “likes” the player who has liked their advertisement, the digital platform preferably automatically creates a mutual connection, granting the team or club access to the player’s profile and enabling direct communication, see FIG. 14.

If a team or club “dislikes” the player, the player is removed from the team’s or club’s list of available candidates and no match is created.

### Monetization Model

The digital platform may generate revenue through:

AdvertisingBrands and organizations can promote their products or services to a highly targeted audience.

Premium FeaturesPaid subscriptions allow for additional benefits like enhanced profile visibility, detailed analytics, and advanced search filters.

Connection Fees: sers may pay a fee to directly connect with teams, players, or agents for specific opportunities.

The digital platform may provide automated video analysis reports and performance improvement recommendations as a paid analytical service generated by the processing engine.

Access to prioritized club recommendation lists may be provided as part of a subscription-based decision support service.

The digital platform, such as implemented in the form of an app, revolutionizes how stakeholders interact in the sports industry. By bridging the gap between players, teams, and other parties, the digital platform creates a seamless ecosystem for talent discovery, career growth, and community engagement. The digital platform eliminates inefficiencies, accelerates opportunities, and empowers users to build their professional sprots network efficiently.

The digital platform facilitates connections within a sports ecosystem, such using a mobile or web-based application. The digital platform enables players to create profiles including personal statistics, playing positions, achievements, and multimedia content. The digital platform also allows players to set visibility preferences to control access to their profiles. The digital platform further enables teams or clubs to register profiles and specify recruitment needs and opportunities. The digital platform can also be used to provide sponsors, agents, and supporters with profile creation and interaction capabilities tailored to their respective roles.

In an embodiment, the digital platform utilizes an AI-powered matching algorithm to recommend connections between players and teams based on predefined criteria, such skills, positions, and availability.

In an embodiment, the matching algorithm generates a multidimensional player vector derived from performance statistics, positional metadata, historical engagement signals, and availability status.

The system computes a compatibility score between the player vector and a club requirement vector using a weighted similarity function, wherein the weights are dynamically adjusted based on historical successful matches stored in the database.

In an embodiment, the digital platform facilitates secure communication and scheduling tools within the application for tryouts, meetings, and/or sponsorship discussions.

The digital platform can be used to generate revenue through targeted advertising, subscription-based premium features, and/or connection fees for direct interactions between users. The digital platform may be configured to provide monetized services including targeted advertising delivery, subscription-based feature access, and/or fee-based connection facilitation between users.

In an embodiment, the digital platform can also be used by players to express interest in team recruitment ads via a search functions.

In an embodiment, the digital platform provides teams or clubs with an interface, such a swipe-based interface, to review interested players and thereby enables the teams or clubs to “like” a player to match, granting access to their profile and direct communication. The interface can also be used by teams or clubs to remove a player from the team’s or club’s recruitment pool if the team or club “disliked” the player using the interface, ensuring no match is created.

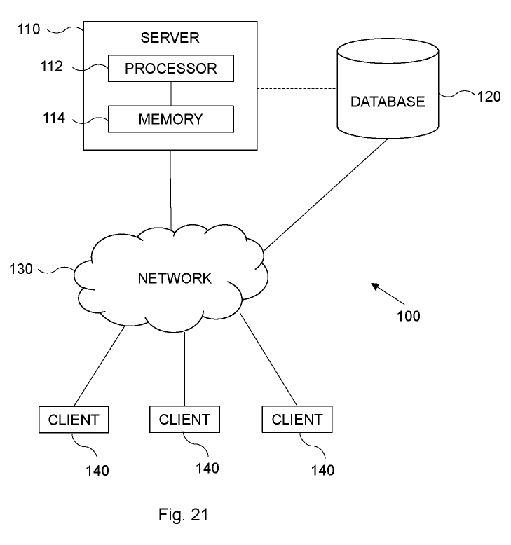

The digital platform could be implemented as a method, in particular a computer-implemented method, and a system 100, see FIG. 21. The system 100 preferably comprises at least one processor 112 and at least one memory 114 in communication with the at least one processor 112 and storing instructions, which when executed by the at least one processor 112, cause the at least one processor 112 to implement the digital platform as described herein.

FIG. 21 illustrates an example system 100 for providing a digital platform designed to connect players, teams, sponsors, agents, and/or supporters within a sports ecosystem according to various embodiments. The various components of system 100 are implemented at least partially by hardware at one or more computing devices, such as one or more hardware processors executing instructions stored in one or more memories for performing various functions described herein. The system 100 in FIG. 21 illustrates only one of many possible arrangements of components to perform the functionality described herein. Other arrangements may include fewer or different components, and the division of work between the components may vary depending on the arrangement.

In an embodiment, the system 100 includes a server 110 comprising a processor 112 and a memory 114, a database 120, a communication network 130, and one or more clients 140. Each of the server 110, the database 120, and the clients 140 is in wired or wireless communication with the network 130.

In an embodiment, the server 110 comprises one or more servers, computers, processors 112, webpage servers, database servers, and/or computing devices to communicate with the database 120 and/or clients 140 via the network 130. The server 110 hosts one or more applications, websites, social networks, and/or other visual or user interface mechanisms related to the techniques and data described herein, i.e., the digital platform designed to connect players, teams, sponsors, agents, and/or supporters within a sports ecosystem. The server 110 may be located at one or more geographically distributed locations. Although one server 110 is shown in FIG. 21, the system 100 may, depending on the embodiment, comprise one, two, or any number of servers 110, which may work alone and/or collectively to provide the digital platform functionality described herein.

The database 120 comprises one or more databases, data stores, or storage devices to store and maintain user profiles, data associated with user profiles, data associated with use of or access to user profiles, data derived from user profiles, and/or instructions for use by the server 120 and/or the clients 140. The database 120 may, in some embodiments, be located at one or more geographically distributed locations relative to server 110. The server 110 and/or the clients 140 may, in some embodiments, access the database 120 via the network 130. Alternatively, the server 110 may access the database 120 without use of the network 130. As another alternative, the database 120 may be included within the server 110 instead of or as a complement to the memory 114. The system 100 may, depending on the embodiment, comprise one, two, or any number of databases 120 to individually and/or collectively store the data described herein.

The clients 140 comprise computing devices, including but not limited to, work stations, personal computers, general purpose computers, laptops, Internet appliances, hand-held devices, wireless devices, wired devices, portable or mobile devices, wearable computers, cellular or mobile phones, portable digital assistants (PDAs), smart phones, tablets, multi-processor systems, microprocessor-based or programmable consumer electronics, game consoles, set-top boxes, network PCs, mini-computers, and the like. Each of the clients 140 includes applications, software, and/or other executable instructions to facilitate various aspects of the techniques described herein. The clients 140 may also include additional applications or other interface capabilities to communicate with the server 110 and/or the database 120. The clients 140 may, depending on the embodiment, be located geographically dispersed from each other, the server 110, and/or the database 120.

In an embodiment, the clients 140 may be used by users or members of an online digital platform, i.e., the sports ecosystem, such as in the form of registered users or members, to login and conduct activity on the digital platform.

The network 110 comprises a communications network, such as a local area network (LAN), a wireless LAN (WLAN), a wide area network (WAN), a wireless WAN (WWAN), a metropolitan area network (MAN), an ad hoc network, an intranet, an extranet, a virtual private network (VPN), a portion of the Internet, the Internet, a portion of a public switched telephone network (PSTN), a cellular network, or a combination of two or more such networks. When the network 110 comprises a public network, security features (e.g., virtual private network/secure sockets layer (VPN/SSL) secure transport) may be included to ensure authorized access within system 100.

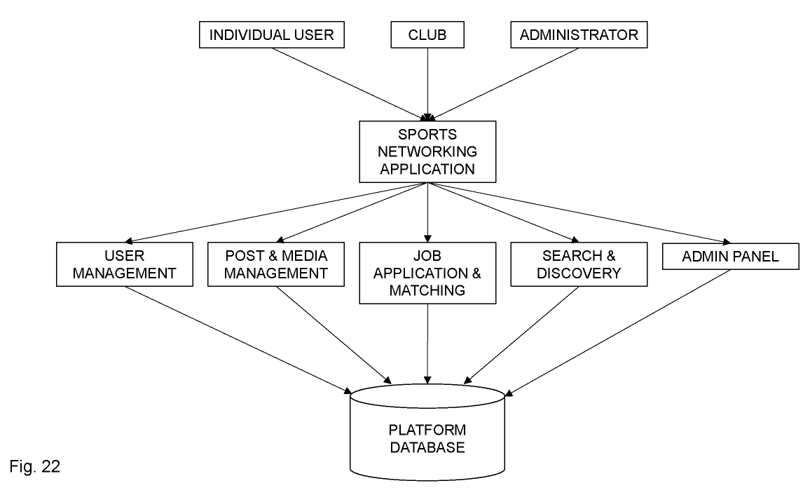

The digital platform has, in an embodiment as shown in FIG. 22, three main user roles: individual users, clubs and administrator. Individual users could be players or supporters and are able to set up their profiles, post in the feed, and search for clubs or other players. Players as users can apply for job openings and track application status and respond to interests shown by clubs. Clubs set up and manage their club profiles, post generic posts or job openings, and assign sub-administrators. Clubs can search for players, view details of other clubs, and review/manage incoming applications. Administrator oversees player and club management, analytics, moderate content, and manage other details. The administrator ensures compliance, safety, and proper operational flow of the ecosystem.

A database, such as a MySQL database, can be implemented to store user profiles (players, clubs, administrators), posts, job applications, and interaction details. A backend, such a Laravel backend, may be used to handle authentication, business logic, and data processing, and exposes secure application programming interfaces (APIs) for the mobile frontend to interact with user-generated content, applications, and administrator operations.

The digital platform allows players to complete their profile and access their dashboard They can follow other users and engage with their content, post their own content, search for clubs or players, apply to jobs, receive and respond to club interests, track their application statuses and communicate/chat with clubs.

The digital platform allows clubs to complete their profile and access their dashboard. They can post job openings, create sub-admins to create posts, search and view individual users, review applications through a swipe-based interface, accept a job request creating a match/reject a job request notification to the user, and communicate/chat with individual users.

Administrator manages users and content across the digital platform including, for instance, dashboard, individual (user) management, club management, analytics, and reported content.

FIG. 22 illustrates an example of a level 0 digital flow diagram (DFD) of the digital platform. FIG. 22 shows the three entities: individual users, clubs and administrator. Individual users can set up profile, apply for jobs, and interact with feed/posts. Clubs can set up profile, post job openings, manage sub-admins, view players, show interests, and manage applications. The administrator manages users, views analytics, and moderates platform activity

The central process is the “Sports Networking Platform”, i.e., the digital platform that handles all data processing, business logic, and user interactions.

A user database stores individual users, club, and sub-admin account details. Posts & media holds post content, media files (image/video/audio), and post metadata. Job applications track all submitted applications, statuses, and match info, and reports & flags contains data on reported posts, users, and moderation actions.

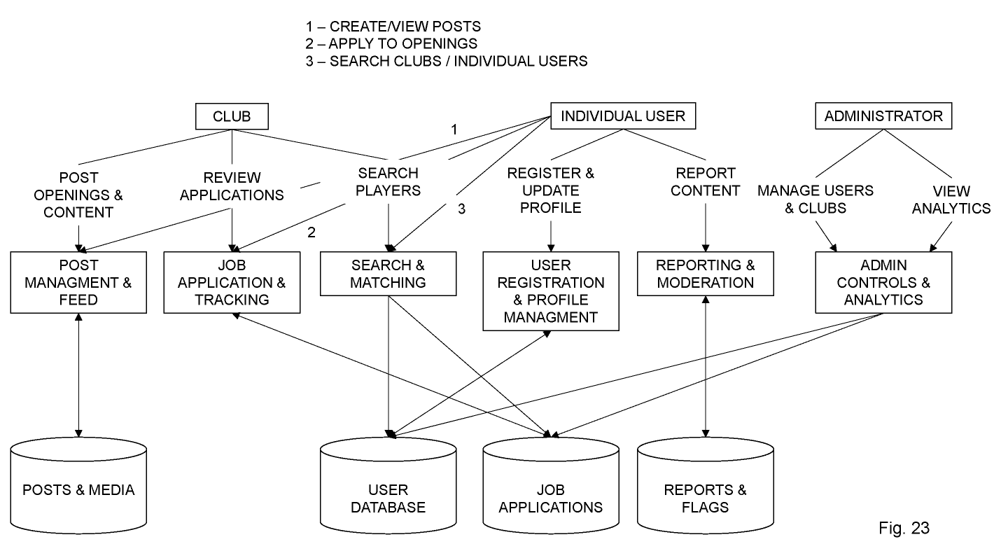

FIG. 23 a level 1 DFD of the digital platform. User Registration & Profile Management handles registration and updates for individual users, clubs, and sub-admins, and stores data in the user database. Post Management & Feed manages creation and display of posts (generic and job openings), handles content approval (for sub-admins), and connects to the Posts & Media data store. Job Applications & Tracking allows players to apply to jobs and clubs to review/respond, tracks application status and matches, and interacts with the Job Applications data store. Search & Matchmaking allows users to search other individual users and clubs and vice-versa, and leverages user database and applications to return contextual results. Reporting & Moderation enables user to report inappropriate content or users, administrator reviews and moderates flagged items, stored in Reports & Flags data store. Admin Controls & Analytics allows the administrator to manage platform users and views analytics (e.g., retention, spam reports, demographics) and pulls from multiple data stores: User and Application data.

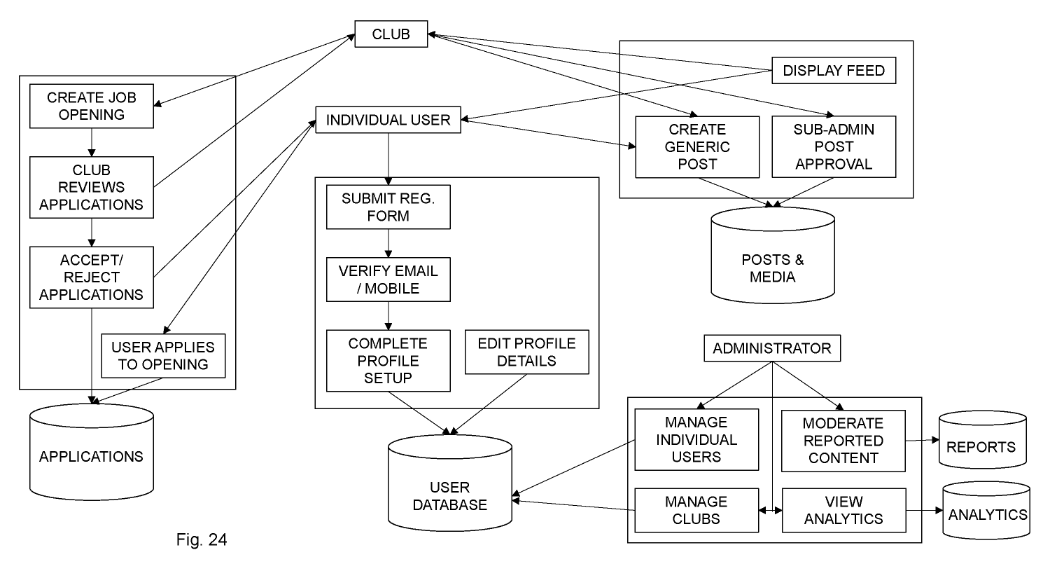

FIG. 24 a level 2 DFD of the digital platform. User Registration & Profile Management includes Submit Registration Form: Basic details submitted, Verify Email/Mobile: Validation through OTP/SMS gateway, Complete Profile Setup: Player or Club adds sport-specific details, and Edit Profile Details: Ongoing profile updates. Post Creation & Feed includes Create Generic Post: Players can share updates/media, Create Job Opening: Clubs create job posts with roles and requirements, Sub-Admin Post Approval: Posts by sub-admins need approval by the club admin, and Display Feed: Shows approved posts to users in the feed. Job Applications & Matchmaking includes Users Applies to Opening: Application is recorded and stored, Club Reviews Applications: Swipe-based reviewing begins, and Clubs Accepts the invitation: Creates a match and updates affiliation. Admin Controls & Moderation includes Manage Individual users: View, activate, deactivate, or delete user accounts, Manage Clubs: Same functions as above for clubs, Moderate Reported Content: Reviews reports made by users, and View Analytics: See user retention, spam trends, and region stats.

The invention relates to a computer-implemented method for operating a digital platform that connects participants in a sports ecosystem. The method comprises (a) storing, in a database, profile records for a plurality of users including at least player profiles and club profiles. Each player profile includes player-related data comprising a sports identifier, position data, performance statistics, availability status, and achievement data. The method also includes (b) generating, by one or more processors and for a player profile, a player vector derived from a set of features extracted from the player-related data included in the player profile. The method further comprises (c) generating, by the one or more processors and for a club profile, a club requirement vector derived from a recruitment post of the club profile. The recruitment post specifies sport, position requirement, league division and location. The method additionally comprises (d) computing a compatibility score between the player vector and the club requirement vector using a weighted similarity function that applies a plurality of feature weights. The method also comprises (e) producing, based on the compatibility score, a ranked recommendation output comprising at least one of (i) a recruitment candidate player set associated with recruitment post of the club profile or (ii) a set of recommended recruitment posts for the player profile. The method further comprises (f) receiving, via a client device interface, an application interest signal from the player for a recruitment post of the set of recommended recruitment posts. The method comprises (g) presenting, to a club user associated with the club profile, an evaluation interface that sequentially renders candidate player profiles associated with application interest signals for the recruitment post and that accepts an accept input or a reject input for each rendered candidate player profile. The method further comprises (h) in response to receiving the accept input by the club user for a candidate player profile for which the player previously generated the application interest signal, creating a mutual connection record that authorizes the club user to access player-related data of the player profile and enabling direct messaging between the club user and the player via the digital platform, and (i) in response to receiving the reject input by the club user, removing the candidate player profile from the recruitment candidate set associated with the recruitment post without creating the mutual connection record.

A user in terms of a player has a player profile stored in the database. The player profile then comprises player-related data of the user including, a sports identifier, position data, performance statistics, availability status and achievement data. The sports identifier includes or represents an identifier of the sport that the user practices, such as football handball, ice hockey or floorball as shown in FIGS. 20A and 20B. The position data includes or represents the particular position of the user in the sport as identified by the sports identifier, such as goal keeper, forward, defense, etc. Performance statistics can include various information relating to the performance of the user as player in his/her sport. Such performance statistics could include offensive performance statistics, defensive performance statistics, passing and possession statistics, physical and availability metrics, ice time metrics, faceoffs and situational play metrics, goal-tender specific metrics, etc.

As an example, offensive performance statistics could, depending on the particular sports, include some or all of goals scored, assists, shots per match, shots on target or goal, shooting percentage, power-play goals or points, etc. Illustrative, but non-limiting, examples of defensive performance statistics include tackles per match, interceptions, clearances, blocks, duels won (ground and aerial), fouls committed / suffered, and penalty minutes. Passing and possession statistics indicate contribution to ball circulation and control and include, for instance, pass completion rate, passes per match, progressive passes, passes into final third, long balls completed, touches per match, and ball losses / dispossessions.

Physical and availability metrics include, for example, minutes played, matches started, distance covered per match, sprints per match, top speed, injury record / availability rate. Ice time metrics include, for example, average time on ice (TOI), even‑strength TOI, power‑play TOI, short‑handed TOI, and shifts per game. Faceoffs and situational play metrics include, for instance, faceoff win percentage, faceoffs taken, faceoffs won in offensive/defensive zone, etc. Goal-tender specific metrics include, for instance, save percentage, goals‑against average (GAA), shots faced, etc.

Availability status can include information of the availability of the player, such as if he or she is already signed to club and then when that contract ends, if the player is not signed to any club and is currently available, current injuries, etc.

Achievement data can include various data relating to the career of the player within the sport and refers to outcomes, honors, milestones, and recognitions that reflect what the player has accomplished. Such data is often used in career summaries, awards, contracts, scouting profiles, hall‑of‑fame considerations, or legal/administrative contexts. Illustrative, but non-limiting, examples of such achievement data include team-based achievements, such as league championships won, cup/tournament victories, playoff appearances, promotion to higher league, season finishes, etc., individual awards and hours, such as most valuable player (MVP) awards, player of the year or season, best forward / defender, etc., top scorer, all-star selections, rookie of the year, etc., statistical milestones, such as career goals/points milestones, season scoring records, most assists in a season, etc., records held, etc.

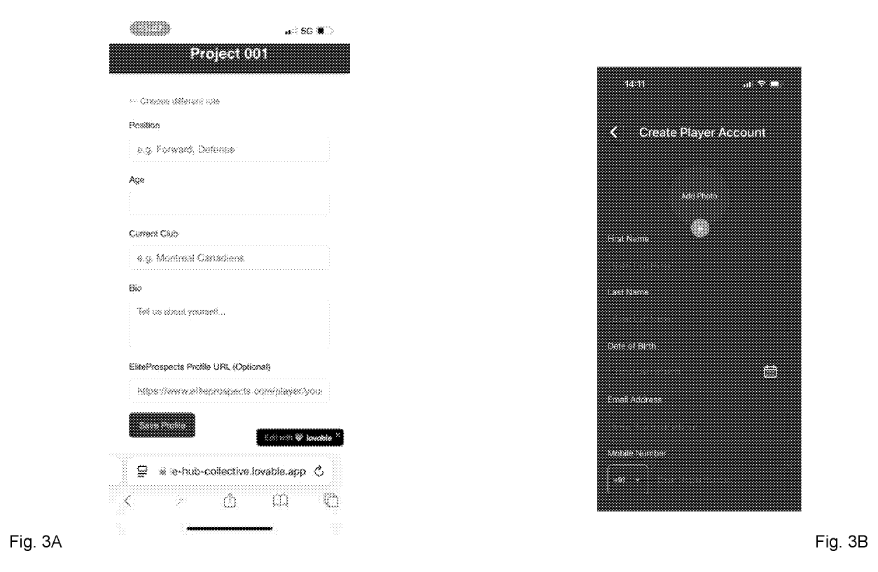

FIGS. 3A to 7B illustrate examples of data included in player profiles.

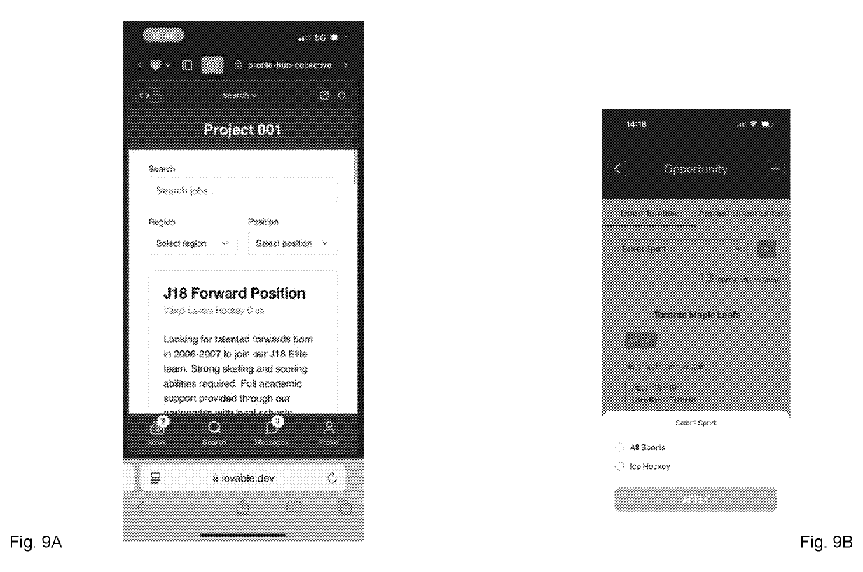

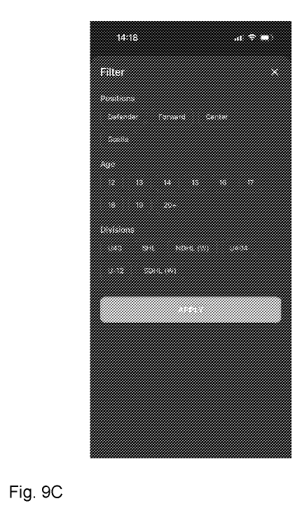

A player vector is derived from a set of features extracted from the player-related data included in the player profile. This player vector is thereby a condensed representation of the player-related data included in the player profile but formatted in such a way that it can be used to compute a matching, i.e., the compatibility score, with a corresponding recruitment vector that is a corresponding condensed representation of a recruitment post of a club profile. As is shown in FIGS. 8A-9B such a recruitment post could include information of the particular sport, e.g., football or ice hockey, position requirement, such as forward, defense, goal keeper, league division, which particular division that the club is currently playing in and where a new position is available and location, such as information of the particular home location of the club.

A respective compatibility score is computed based on the club requirement vector and player vectors and where this compatibility score is representative of the match between the requirements presented in the recruitment post and the player-related data of the player profile. A high compatibility score thereby represents a good match between the particular player and the recruitment post in terms of the player matches most, if not all, the requirements in the recruitment post. A low compatibility score correspondingly indicates a poor match between the player and the recruitment post.

The compatibility score can then be used by the player to get a ranked recommendation output listing a set of recommended recruitment posts where the user’s player profile has a good match with the recruitment post, i.e., results in compatibility score above a threshold score.

Correspondingly, the compatibility score could be used by the club to get a ranked recommendation output listing a set of recruitment candidate players where the player profiles had a good match with the recruitment post, i.e., results in compatibility score above a threshold score.

In these embodiments, the same or different threshold score could be used to get the ranked recommendation output listing the set of recommended recruitment posts as the ranked recommendation output listing the set of recruitment candidate players. The threshold score(s) could be predefined, set by the administrator, and/or by the user(player) or the club.

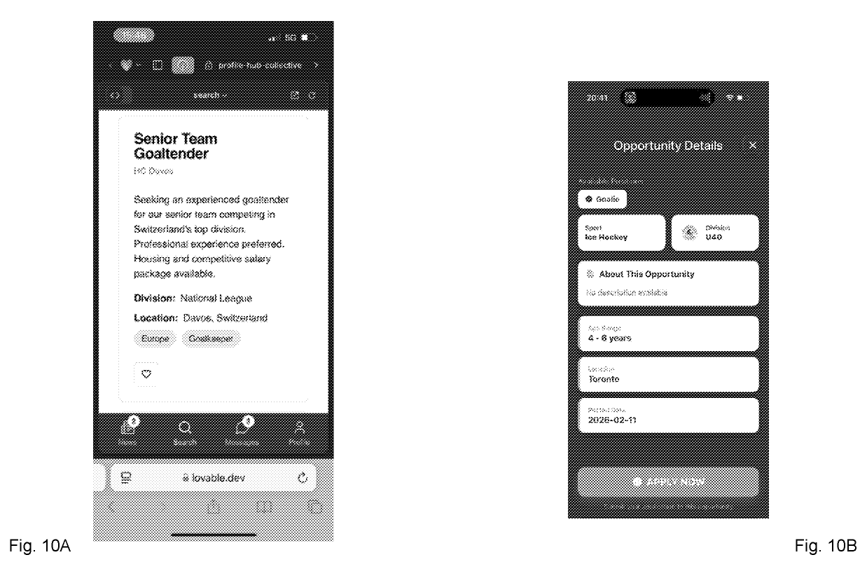

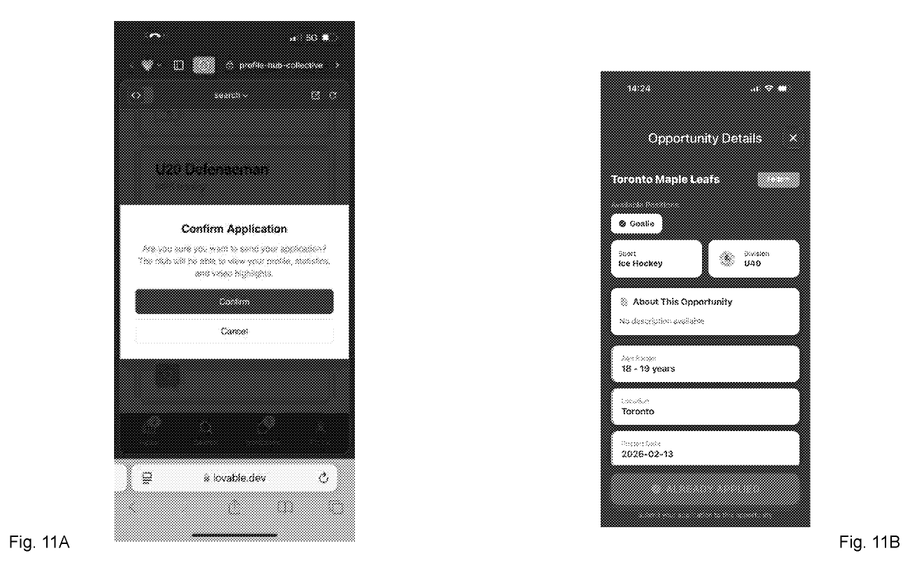

The user can then use the ranked recommendation output listing the set of recommended recruitment posts to apply for any recommended recruitment post using the digital platform, such as by pressing like to the recruitment post, see FIG. 10A, or apply for the recruitment post, see FIG. 10B. In such a case, the client device interface generates an application interest signal. A club user associated with or managing the club profile is then presented, using an evaluation interface, the candidate player profiles that are associated with application interest signals, i.e., for which the users/players have applied for the recruitment post of the club. The club user can then use the evaluation interface to accept or reject the various applications from the candidate players.

If the club user is interested in in a player, i.e., accepts the application from the player, a mutual connection record is generated that authorizes the club user to access player-related data of the player profile. In addition, the accept input, enables direct messaging between the club user and the player via the digital platform, see FIGS. 14A, 14B.

However, if the club user is not interested in a candidate player for the particular recruitment post, he/she can use the evaluation interface to generate a reject input, which removes the candidate player profile from the recruitment candidate set associated with recruitment post without creating the mutual connection record.

In an embodiment, the further comprises (j) updating at least one of the feature weights used in the weighted similarity function based on feedback signals derived from at least one accept or reject input and at least one historical successful match stored in the database.

The input by the club user can thereby be used to update one or more feature weights used weighted similarity function to compute the compatibility scores. This means that the matching between recruitment post(s) of the club and players will be adjusted based on the outcome of past matchings, i.e., based on whether the club users accepted or rejected the matchings between a recruitment post and candidate player profiles. Such a dynamic updating of the feature weight(s) means that the weighted similarity function learns from past matchings and will thereby improve the matching between player profiles and recruitment posts for the particular club.

In an embodiment, the historical engagement signals include at least one of follower count, profile views, applications submitted, message interactions, or content interactions recorded by the digital platform.

In an embodiment, step (g) comprises generating, by the one or more processors and for the player profile, the player vector by normalizing and encoding the set of features extracted from the player-related data included in the player profile.

In an embodiment, step (f) comprises displaying a confirmation dialog prior to transmitting the application interest signal to the club user.

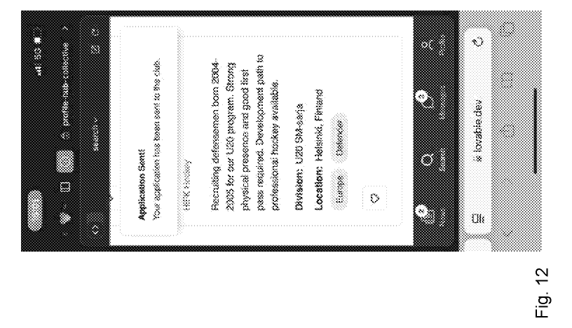

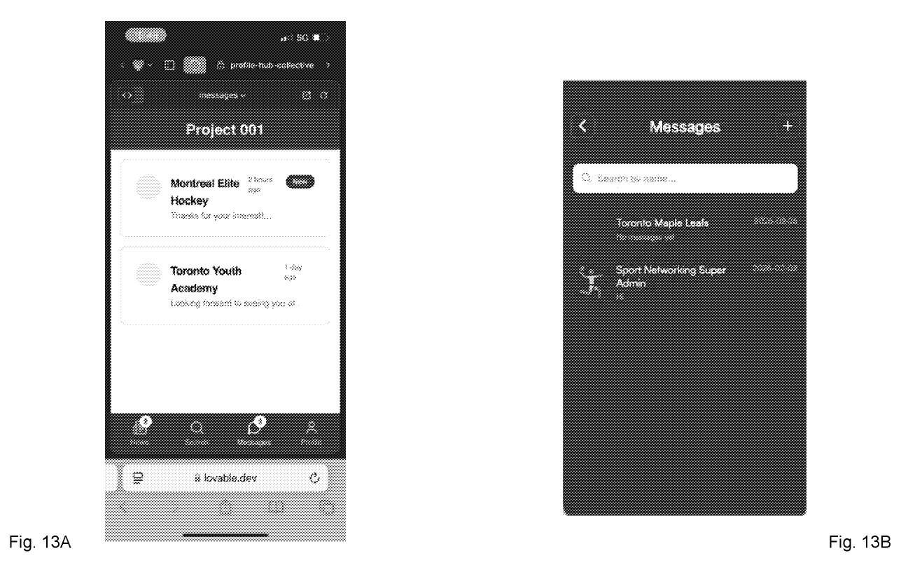

An example of such a confirmation dialog is shown in FIG. 11A.

In an embodiment, step (f) further comprises detecting a previously submitted application interest signal for the recruitment post by the player and, responsive thereto, displaying an application status indicator and disabling duplicate submissions for the recruitment post.

An example of such an application status indicator is shown in FIG. 11B.

In an embodiment, the method further comprising providing a search interface that filters recruitment posts by at least one of sport, location, position, or league division and that outputs matching recruitment posts for player browsing.

Examples of such search interfaces are shown in FIGS. 9A and 9B.

In an embodiment, the method further comprising processing player-uploaded video content using computer vision to extract one or more video-derived performance indicators, and incorporating the video-derived performance indicators into the player vector.

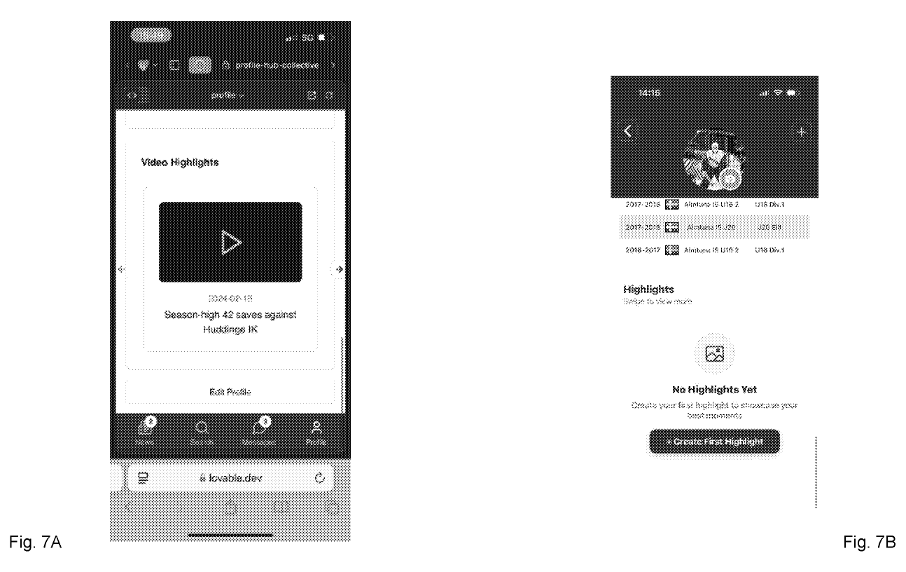

The digital platform can thereby use computer vision to extract video-derived performance indicators from any video content uploaded by the player on his/her player profile, see FIG. 7A. Illustrative, but non-limiting, examples of such performance indicators that could be extracted from a video content of an ice hockey match or training include skating speed, shot velocity, positional movement patterns, and puck interaction metrics. The extracted video-derived features could then be incorporated into the player vector to improve matching accuracy.

In an embodiment, the further comprising generating, based on the video-derived performance indicators, an individualized training recommendation output identifying at least one performance deficiency and at least one corrective action.

The video-derived performance indicators could not only be used to improve the matching between players and recruitment posts but could also be used to provide and display individualized training recommendation output identifying at least one performance deficiency and at least one corrective action. Such information is highly helpful for players to improve their skills and notifying deficiencies.

In an embodiment, the method further comprising enforcing privacy and visibility controls by selectively restricting, based on a player-selected visibility setting, access to at least one of the player profile or the player’s availability status until the mutual connection record is created.

In an embodiment, step (j) comprises storing each accept or reject input as a labeled training example and dynamically refining subsequent recommendation outputs for the club user based on detected recruiter preference patterns.

In an embodiment, the method further comprising, after creating the mutual connection record, providing at least one of (i) a scheduling interface for tryouts or interviews, or (ii) a secure messaging channel restricted to the mutually connected users.

The invention also relates to a system 100 for operating a digital platform connecting participants in a sports ecosystem. The system 100 comprises one or more processors 112 and one or more memories 114 storing instructions that, when executed by the one or more processors 112, cause the one or more processors 112 to store, in a database 120, profile records for a plurality of users including at least player profiles and club profiles. Each player profile includes player-related data comprising a sports identifier, position data, performance statistics, availability status, and achievement data. The instructions also cause the one or more processors 112 to generate, for a player profile, a player vector derived from a set of features extracted from the player-related data included in the player profile. The instructions also cause the one or more processors 112 to generate, for a club profile, a club requirement vector derived from a recruitment post of the club profile, wherein the recruitment post specifies sport, position requirement, league division and location. The instructions also cause the one or more processors 112 to compute a compatibility score between the player vector and the club requirement vector using a weighted similarity function that applies a plurality of feature weights. The instructions also cause the one or more processors 112 to produce, based on the compatibility score, a ranked recommendation output comprising at least one of (i) a recruitment candidate player set associated with recruitment post of the club profile or (ii) a set of recommended recruitment posts for the player profile. The instructions also cause the one or more processors 112 to receive an application interest signal from the player for a recruitment post of the set of recommended recruitment posts. The instructions also cause the one or more processors 112 to present, to a club user associated with the club profile, an evaluation interface that sequentially renders candidate player profiles associated with application interest signals for the recruitment post and that accepts an accept input or a reject input for each rendered candidate player profile. The instructions also cause the one or more processors 112 to, in response to receiving the accept input by the club user for a candidate player profile for which the player previously generated the application interest signal, create a mutual connection record that authorizes the club user to access player-related data of the player profile and enabling direct messaging between the club user and the player via the digital platform. The instructions also cause the one or more processors 112 to, in response to receiving the reject input by the club user, remove the candidate player profile from the recruitment candidate set associated with the recruitment post without creating the mutual connection record

In an embodiment, the instructions further cause the one or more processors 112 to update at least one of the feature weights used in the weighted similarity function based on feedback signals derived from at least one accept or reject input and at least one historical successful match stored in the database.

In an embodiment, the instructions further cause the one or more processors 112 to generate the player vector by normalizing and encoding the set of features extracted from the player-related data included in the player profile.

In an embodiment, the instructions further cause the one or more processors 112 to detect a previously submitted application interest signal for the recruitment post by the player and, responsive thereto, generate an application status indicator and disable duplicate submissions for the recruitment post.

In an embodiment, the instructions further cause the one or more processors 112 to provide a search interface that filters recruitment posts by at least one of sport, location, position, or league division and that outputs matching recruitment posts for player browsing.

In an embodiment, the instructions further cause the one or more processors 112 to enforce privacy and visibility controls by selectively restricting, based on a player-selected visibility setting, access to at least one of the player profile or the player’s availability status until the mutual connection record is created.

The invention also relates to a non-transitory computer-readable medium storing instructions that, when executed by one or more processors 112, cause the one or more processors 112 to perform operations comprising storing, in a database 120, profile records for a plurality of users including at least player profiles and club profiles. Each player profile includes player-related data comprising a sports identifier, position data, performance statistics, availability status, and achievement data. The operations also comprise generating, by one or more processors 112 and for a player profile, a player vector derived from a set of features extracted from the player-related data included in the player profile. The operations also comprise generating, by the one or more processors 112 and for a club profile, a club requirement vector derived from a recruitment post of the club profile. The recruitment post specifies sport, position requirement, league division and location. The operations also comprise computing a compatibility score between the player vector and the club requirement vector using a weighted similarity function that applies a plurality of feature weights. The operations also comprise producing, based on the compatibility score, a ranked recommendation output comprising at least one of (i) a recruitment candidate player set associated with recruitment post of the club profile or (ii) a set of recommended recruitment posts for the player profile. The operations also comprise receiving, via a client device interface, an application interest signal from the player for a recruitment post of the set of recommended recruitment posts. The operations also comprise presenting, to a club user associated with the club profile, an evaluation interface that sequentially renders candidate player profiles associated with application interest signals for the recruitment post and that accepts an accept input or a reject input for each rendered candidate player profile. The operations also comprise, in response to receiving the accept input by the club user for a candidate player profile for which the player previously generated the application interest signal, creating a mutual connection record that authorizes the club user to access player-related data of the player profile and enabling direct messaging between the club user and the player via the digital platform. The operations also comprise, in response to receiving the reject input by the club user, removing the candidate player profile from the recruitment candidate set associated with the recruitment post without creating the mutual connection record.

The various embodiment described above for the computer-implemented method also apply to the system and the non-transitory computer-readable medium.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

1. A computer-implemented method for operating a digital platform that connects participants in a sports ecosystem, the method comprising:
(a) storing, in a database, profile records for a plurality of users including at least player profiles and club profiles, wherein each player profile includes player-related data comprising a sports identifier, position data, performance statistics, availability status, and achievement data;
(b) generating, by one or more processors and for a player profile, a player vector derived from a set of features extracted from the player-related data included in the player profile;
(c) generating, by the one or more processors and for a club profile, a club requirement vector derived from a recruitment post of the club profile, wherein the recruitment post specifies sport, position requirement, league division and location;
(d) computing a compatibility score between the player vector and the club requirement vector using a weighted similarity function that applies a plurality of feature weights;
(e) producing, based on the compatibility score, a ranked recommendation output comprising at least one of (i) a recruitment candidate player set associated with recruitment post of the club profile or (ii) a set of recommended recruitment posts for the player profile;
(f) receiving, via a client device interface, an application interest signal from the player for a recruitment post of the set of recommended recruitment posts;
(g) presenting, to a club user associated with the club profile, an evaluation interface that sequentially renders candidate player profiles associated with application interest signals for the recruitment post and that accepts an accept input or a reject input for each rendered candidate player profile;
(h) in response to receiving the accept input by the club user for a candidate player profile for which the player previously generated the application interest signal, creating a mutual connection record that authorizes the club user to access player-related data of the player profile and enabling direct messaging between the club user and the player via the digital platform; and
(i) in response to receiving the reject input by the club user, removing the candidate player profile from the recruitment candidate set associated with the recruitment post without creating the mutual connection record.

2. The method of claim 1, further comprising:
(j) updating at least one of the feature weights used in the weighted similarity function based on feedback signals derived from at least one accept or reject input and at least one historical successful match stored in the database.

3. The method of claim 2, wherein the historical engagement signals include at least one of follower count, profile views, applications submitted, message interactions, or content interactions recorded by the digital platform.

4. The method of claim 1, wherein step (g) comprises generating, by the one or more processors and for the player profile, the player vector by normalizing and encoding the set of features extracted from the player-related data included in the player profile.

5. The method of claim 1, wherein step (f) comprises displaying a confirmation dialog prior to transmitting the application interest signal to the club user.

6. The method of claim 1, wherein step (f) further comprises detecting a previously submitted application interest signal for the recruitment post by the player and, responsive thereto, displaying an application status indicator and disabling duplicate submissions for the recruitment post.

7. The method of claim 1, further comprising providing a search interface that filters recruitment posts by at least one of sport, location, position, or league division and that outputs matching recruitment posts for player browsing.

8. The method of claim 1, further comprising processing player-uploaded video content using computer vision to extract one or more video-derived performance indicators, and incorporating the video-derived performance indicators into the player vector.

9. The method of claim 8, further comprising generating, based on the video-derived performance indicators, an individualized training recommendation output identifying at least one performance deficiency and at least one corrective action.

10. The method of claim 1, further comprising enforcing privacy and visibility controls by selectively restricting, based on a player-selected visibility setting, access to at least one of the player profile or the player’s availability status until the mutual connection record is created.

11. The method of claim 1, wherein step (j) comprises storing each accept or reject input as a labeled training example and dynamically refining subsequent recommendation outputs for the club user based on detected recruiter preference patterns.

12. The method of claim 1, further comprising, after creating the mutual connection record, providing at least one of (i) a scheduling interface for tryouts or interviews, or (ii) a secure messaging channel restricted to the mutually connected users.

13. A system for operating a digital platform connecting participants in a sports ecosystem, the system comprising:
one or more processors;
one or more memories storing instructions that, when executed by the one or more processors, cause the one or more processors to:
store, in a database, profile records for a plurality of users including at least player profiles and club profiles, wherein each player profile includes player-related data comprising a sports identifier, position data, performance statistics, availability status, and achievement data;
generate, for a player profile, a player vector derived from a set of features extracted from the player-related data included in the player profile;
generate, for a club profile, a club requirement vector derived from a recruitment post of the club profile, wherein the recruitment post specifies sport, position requirement, league division and location;
compute a compatibility score between the player vector and the club requirement vector using a weighted similarity function that applies a plurality of feature weights;
produce, based on the compatibility score, a ranked recommendation output comprising at least one of (i) a recruitment candidate player set associated with recruitment post of the club profile or (ii) a set of recommended recruitment posts for the player profile;
receive an application interest signal from the player for a recruitment post of the set of recommended recruitment posts;
present, to a club user associated with the club profile, an evaluation interface that sequentially renders candidate player profiles associated with application interest signals for the recruitment post and that accepts an accept input or a reject input for each rendered candidate player profile;
in response to receiving the accept input by the club user for a candidate player profile for which the player previously generated the application interest signal, create a mutual connection record that authorizes the club user to access player-related data of the player profile and enabling direct messaging between the club user and the player via the digital platform; and
in response to receiving the reject input by the club user, remove the candidate player profile from the recruitment candidate set associated with the recruitment post without creating the mutual connection record.

14. The system of claim 13, wherein the instructions further cause the one or more processors to update at least one of the feature weights used in the weighted similarity function based on feedback signals derived from at least one accept or reject input and at least one historical successful match stored in the database.

15. The system of claim 13, wherein the instructions further cause the one or more processors to generate the player vector by normalizing and encoding the set of features extracted from the player-related data included in the player profile.

16. The system of claim 13, wherein the instructions further cause the one or more processors to detect a previously submitted application interest signal for the recruitment post by the player and, responsive thereto, generate an application status indicator and disable duplicate submissions for the recruitment post.

17. The system of claim 13, wherein the instructions further cause the one or more processors to provide a search interface that filters recruitment posts by at least one of sport, location, position, or league division and that outputs matching recruitment posts for player browsing.

18. The system of claim 13, wherein the instructions further cause the one or more processors to enforce privacy and visibility controls by selectively restricting, based on a player-selected visibility setting, access to at least one of the player profile or the player’s availability status until the mutual connection record is created.

19. A non-transitory computer-readable medium storing instructions that, when executed by one or more processors, cause the one or more processors to perform operations comprising:
storing, in a database, profile records for a plurality of users including at least player profiles and club profiles, wherein each player profile includes player-related data comprising a sports identifier, position data, performance statistics, availability status, and achievement data;
generating, by one or more processors and for a player profile, a player vector derived from a set of features extracted from the player-related data included in the player profile;
generating, by the one or more processors and for a club profile, a club requirement vector derived from a recruitment post of the club profile, wherein the recruitment post specifies sport, position requirement, league division and location;
computing a compatibility score between the player vector and the club requirement vector using a weighted similarity function that applies a plurality of feature weights;
producing, based on the compatibility score, a ranked recommendation output comprising at least one of (i) a recruitment candidate player set associated with recruitment post of the club profile or (ii) a set of recommended recruitment posts for the player profile;
receiving, via a client device interface, an application interest signal from the player for a recruitment post of the set of recommended recruitment posts;
presenting, to a club user associated with the club profile, an evaluation interface that sequentially renders candidate player profiles associated with application interest signals for the recruitment post and that accepts an accept input or a reject input for each rendered candidate player profile;
in response to receiving the accept input by the club user for a candidate player profile for which the player previously generated the application interest signal, creating a mutual connection record that authorizes the club user to access player-related data of the player profile and enabling direct messaging between the club user and the player via the digital platform; and
in response to receiving the reject input by the club user, removing the candidate player profile from the recruitment candidate set associated with the recruitment post without creating the mutual connection record.
